(19) United States
(12) Patent Application Publication
(10) Pub. No.: US 2012/0203469 A1
(43) Pub. Date: Aug. 9, 2012

(54) METHOD OF EVALUATING TOXICITY LEVEL OF A PATIENT UNDERGOING A CANCER TREATMENT

(75) Inventors: Martin Weibrecht, Eindhoven (NL); Carolina Ribbing, Eindhoven (NL); Marco Daniel Pascal Lierfeld, Eindhoven (NL); Frank Wartena, Eindhoven (NL)

(73) Assignee: KONINKLIJKE PHILIPS ELECTRONICS N.V., Eindhoven (NL)

(21) Appl. No.: 13/500,647

(22) PCT Filed: Sep. 27, 2010
(86) PCT No.: PCT/IB2010/054332

§ 371 Date: Apr. 6, 2012

(30) Foreign Application Priority Data
Oct. 7, 2009 (EP) 09172400.5

(51) Int. Cl. G06F 19/00

(52) U.S. Cl. 702/19

(57) ABSTRACT

This invention relates to a method and a system of evaluating toxicity level of a patient undergoing a cancer treatment protocol. Patient's related data including biomarkers of toxicity level caused by said cancer treatment are received. These biomarkers of toxicity level are then compared with a range of reference biomarkers of toxicity level caused during a similar cancer treatment. Finally, an alert signal is issued in case the biomarkers of toxicity level fall outside said range of reference biomarkers of toxicity level.

### FIELD OF THE INVENTION

The present invention relates to a method of evaluating toxicity level of a patient undergoing a cancer treatment.

### BACKGROUND OF THE INVENTION

The treatment of cancer is highly complex. Specific treatments and treatment protocols are chosen depending on aspects like specific disease, disease stage, presence or absence of molecular markers, comorbidities, patient history, prior treatments, patient preferences, access to treatment options, and several other factors. Many therapeutic options are associated with fractionated schemes, i.e. the treatment is applied over prolonged periods of time. The most prominent and important examples are chemotherapy, radiotherapy, and concurrent or induction chemo-radiotherapy. For fractionated treatment schemes, therapy monitoring becomes increasingly important. While significant research is executed on the prognosis of therapy response based on treatment monitoring approaches, comparatively little work is spent on monitoring toxicity and side effects. Side effects, however, are the major limiting factors of any treatment. The objective assessment of toxicity introduces a fundamental means for individualized and optimized therapy. The toxicity of fractionated therapies can be assessed by several monitoring approaches. In-vitro diagnosis (IVD) tests like full blood count (FBC) provide insight into the general health status and into specific biochemical processes. The localization of the therapy induced damage can be performed by imaging studies. Inflammatory processes following tissue damage, for instance, are represented in several molecular markers, e.g. CRP, and in a variety of aspects accessible by imaging: increased perfusion, oedema, local bleeding, etc.

Unfortunately, the correlations between specific markers and the severity of the expected side effects are complex, depend highly on the specific treatment settings at the institution and therefore miss objective evaluation. In consequence, detailed diagnosis of toxicity and use of counter measures are based on the individual experience of the treating physician. This can lead to suboptimal results in the treatment of both the primary disease and the side effects.

The inventor of the present invention has appreciated that an improved method of evaluating toxicity level of a patient undergoing a cancer treatment is of benefit, and has in consequence devised the present invention

### SUMMARY DESCRIPTION OF THE INVENTION

It would be advantageous to achieve an improvement in evaluating toxicity level of a patient undergoing a cancer treatment. It would also be desirable to enable improving the quality of care and to personalize the treatment according to individual tolerance to side effects. In general, the invention preferably seeks to mitigate, alleviate or eliminate one or more of the above mentioned disadvantages singly or in any combination. In particular, it may be seen as an object of the present invention to provide a method that solves the above mentioned problems, or other problems, of the prior art.

To better address one or more of these concerns, in a first aspect of the invention a method is presented that evaluates toxicity level of a patient undergoing a cancer treatment protocol, comprising:

receiving patient's related data including biomarkers of toxicity level caused by said cancer treatment,

compare said biomarkers of toxicity level with a range of reference biomarkers of toxicity level caused during a similar cancer treatment, and

issuing an alert signal in case said biomarkers of toxicity level fall outside said range of reference biomarkers of toxicity level.

The fact that the biomarkers toxicity level for the patient is being compared with a “normal” biomarkers toxicity level for a person that is undergoing a similar treatment makes it possible to objectively evaluate the biomarkers toxicity level for each individual patient and thus improve the quality of care and to personalize the treatment according to individual tolerance to side effects.

In one embodiment, the cancer treatment protocol includes set of rules adapted to support a clinician at the respective clinical institute to adhere the cancer treatment protocol as defined by the respective clinical institute. Such rules support clinicians to adhere to the protocols (standard operation procedure: SOP) of the institution in order to get comparable and reliable results of the performed tests, i.e. in order to acquire the biomarkers of toxicity level under reproducible conditions thus delivering markers that are eligible for a meaningful evaluation in a statistical analysis.

In one embodiment, the set of rules are editable by a user as a response to said issued alarm signal so as to modify said cancer treatment protocol. Editing of such rules is beneficial in terms of modifying rules when institution guidelines (SOP) change or in terms of adding new protocols if new treatments (SOPs) are introduced. Rules should not be adapted if treatment changes but rules should preferably cover changes in the treatment or at least exclude patient from further analysis by the system.

In one embodiment, in case the toxicity level of said patient falls within said range of reference biomarkers of toxicity level or if the toxicity level of said patient is considered to be acceptable, said patient's related data including said biomarkers of toxicity level are considered to qualify as reference data, the biomarkers of toxicity level for said patient subsequently being added to said reference biomarkers of toxicity level. Accordingly, a kind of a “feedback loop” is provided so that at a certain point in time—usually when the treatment has been finished and the aim of the treatment is achieved—the physician can assess the patient health status retrospectively and qualify the patient as ‘normal’. In this case, the acquired data of the patient, in particular toxicity related biomarkers and treatment regime along with other patient's related data may be added to the database and even new reference levels of toxicity and normal ranges of the levels may even be calculated. This improves the adaptation of the data/data analysis to the local settings because different clinical institutes may use different rules/protocols. In that way, each respective clinical institute can continuously update their reference data so that it fits their procedures.

In one embodiment, said step of adding the biomarkers of toxicity level for said patient subsequently to said reference biomarkers of toxicity level is done automatically. Thus, this step of adding the patient's related data to the reference biomarkers of toxicity level provides an efficient way of improving the reference database where a user/physician's involvement is not needed. This is preferably done if all parameters acquired during the treatment course were within normal ranges and no sever toxicity has been reported or treated by the treating physician.

In one embodiment, the alert signal further includes adjustment data indicating how the cancer treatment should be adjusted in accordance to the issued alert signal. It is thus possible to correct the treatment method, e.g. the doses that the patient is being given, in accordance to the alert signal.

In one embodiment, the reference biomarkers of toxicity level are associated with patient's related reference data, where prior to comparing said biomarkers of toxicity level with said range of reference biomarkers of toxicity level, a classification is performed based on said patient's related data and said patient's related reference data so as to classify the patient into a category such that the patient's related data at least partly match the patient's related reference data, said comparing being based on comparing the biomarkers of toxicity level for the patient with reference biomarkers of toxicity level within the same or similar category. In that way, by comparing the patient with similar reference patients, e.g. female in the age between 25-30 years old, a more reliable toxicity evaluation is obtained.

In one embodiment, the category is selected from one or more of the following:

the gender of the patient,

the age of the patient,

previous medical history of the patient,

the geographical origin of the patient, and

the treatment regime of the patient.

In one embodiment, the patient's related data further include:

data relating to previous treatments the patient has already undergone, or

data indicating the drug the patient has been given during the previous treatments, or

data indicating the treatments the patient has not yet undergone, or

data indicating the dates of the previous or the coming treatments, or

data indicating the results of the previous treatments, or

an identifier that identifies the patient, or

a combination thereof

In one embodiment, said biomarkers of toxicity level caused by said cancer treatment are evaluated via linear combination of acquired biomarkers of toxicity level.

In one embodiment, the linear combination includes:

a linear combination of the levels of the acquired biomarkers,

a slope of the biomarkers where a current biomarker level is compared with a prior biomarker level,

a curvature change of the biomarkers of toxicity level where the slope of two subsequent levels of a biomarker is compared with the slope of two subsequent levels of said biomarker at a subsequent point in time,

a liner combination of different biomarkers.

Accordingly, for evaluation linear combinations of measured biomarkers may be used, where e.g. linear combination of the levels of the acquired biomarkers may include number of leucocytes, CRP level, etc. The slope of the biomarkers may e.g. include the difference of two levels where a current value minus baseline value before treatment is determined or current value minus prior value. The curvature change means monitoring the difference in slopes so as to indicate increasing speed of deterioration. The linear combination of different biomarkers may e.g. include increasing CRP (inflammation marker) given decreased number of leucocytes. While the individual biomarkers, their slopes or curvatures may be within normal ranges, the combined evaluation may indicate a severe condition. Accordingly, the normal ranges that are evaluated to generate said alerts are then ranges of the results of those linear combinations, i.e. not necessarily the normal ranges of the measured biomarkers themselves.

In a second aspect of the invention a computer program product is presented for instructing a processing unit to execute the above mentioned method steps when the product is run on a computer.

In a third aspect of the invention a system is provided for evaluating toxicity level of a patient undergoing a cancer treatment protocol, comprising:

a receiver adapted to receive patient's related data including biomarkers of toxicity level caused by said cancer treatment,

a database having stored therein a range of reference biomarkers of toxicity level caused during a similar cancer treatment,

a processor adapted to:
compare said biomarkers of toxicity level with said range of reference biomarkers, and
issuing an alert signal in case said biomarkers of toxicity level fall outside said range of reference biomarkers of toxicity level.

In one embodiment, said processor is further adapted to, in case the toxicity level of said patient falls within said range of reference biomarkers of toxicity level or if the toxicity level of said patient is considered to be acceptable, add said patient's related data to said database and thus consider said patient's related data qualifying as reference data, whereby the biomarkers of toxicity level for said patient is subsequently being added to said reference biomarkers of toxicity level.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows an embodiment of a method according to the present invention of evaluating toxicity level of a patient undergoing a cancer treatment protocol, and

FIG. 2 shows an embodiment of a system according to the present invention for evaluating toxicity level of a patient undergoing a cancer treatment protocol.

### DESCRIPTION OF EMBODIMENTS

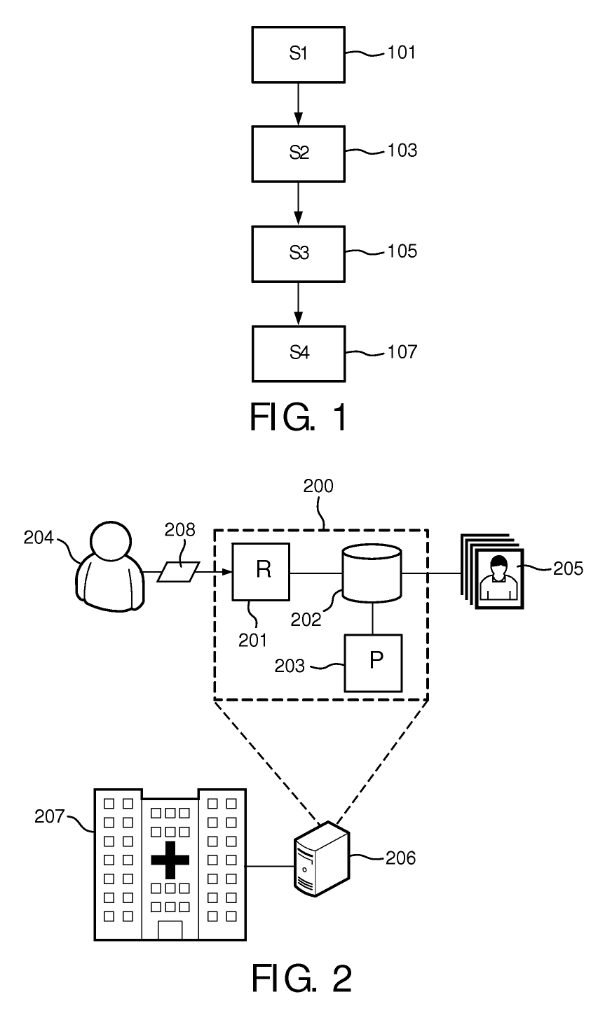

FIG. 1 shows an embodiment of a method according to the present invention of evaluating toxicity level of a patient undergoing a cancer treatment protocol where patient with a specific disease and a specific disease stage is treated according to this cancer treatment protocol. The chosen treatment regime may depend on many aspects, e.g. available treatment options of the hospital. The decision process on the treatment regime can be coded in a rule based system, i.e. where set of rules are adapted to support a clinician at the respective clinical institute to adhere the cancer treatment protocol as defined by the respective clinical institute.

In step (S1) 101, patient's related data including biomarkers of toxicity level caused by said cancer treatment are received. This patient's related data may, in addition to the biomarkers of toxicity level, further include data about previous treatments the patient has already undergone, data about the drug the patient has been given during the previous treatments and treatments the patient has not yet undergone, dates of the previous or the coming treatments, data about the results of the previous treatments, an identifier that identifies the patient, or a combination thereof.

The biomarkers of toxicity level caused by said cancer treatment may be evaluated via linear combination of acquired biomarkers of toxicity level, where the linier combination includes a linear combination of the levels of the acquired biomarkers. As an example, this can be number of leucocytes, CRP (C-reactive protein, cf. e.g. http://en.wikipedia.org/wiki/C-reactive_protein) level, etc. The linear combination may also be slope of the biomarkers where a current biomarker level is compared with a prior biomarker level, e.g. difference of two levels such as current value minus baseline value before treatment or current value minus prior value. The linear combination may also be a curvature of the biomarkers of toxicity level where the slope of two subsequent levels of biomarker is compared with the slope of two subsequent levels of said biomarkers at a subsequent point in time, but this may indicate increasing speed of deterioration. The linear combination may also be a liner combination of different biomarkers e.g. increasing CRP (inflammation marker) given decreased number of leucocytes may indicate a severe condition: building up infection with impaired immune system.

In step (S2) 103, said biomarkers of toxicity level are compared with a range of reference biomarkers of toxicity level caused during a similar cancer treatment. By doing so it possible to objectively evaluate whether the biomarkers toxicity level for the patient is normal or not. This means that the biomarkers of toxicity level of said patient is being compared with reference biomarkers of toxicity level that are considered to be “normal” or acceptable. These reference biomarkers are collected from a group of reference patients that have undergone a similar or identical cancer treatment where the same cancer treatment protocol was followed having toxicity levels that were considered to be normal/acceptable.

These reference biomarkers of toxicity level may further be associated with patient's related reference data, i.e. data or any medical related data about patients that provided these reference biomarkers. These reference data include, but are not limited to: the gender of the patient, the age of the patient, previous medical history of the patient, the geographical origin of the patient, and the treatment regime of the patient. The treatment regime can be highly correlated to the particular treatment, e.g. specific chemotherapy drugs exhibit less toxicity for bone marrow than others. It is thus possible to, prior to comparing said biomarkers of toxicity level with said range of reference biomarkers of toxicity level, to perform a classification where said additional patients related data are used to classify the patient into a classification category such that the patient's related data at least partly match the patient's related reference data. As an example, the classification may be based on comparing the patient with reference patients of the same gender and the same age.

In step (S3) 105, an alert signal is issued in case said biomarkers of toxicity level fall outside said range of reference biomarkers of toxicity level. As an example, if the range that is considered to be “normal” is [1, . . , 2] (these just arbitrary selected numbers), but the toxicity level of the patient is 3 the clinician that is handling the patient will be alerted, e.g. via a computer screen, blinking red light, speech command and the like, so as to inform that the toxicity level is too high. As a response to such an issued alarm signal said set of rules forming said cancer treatment protocol may be editable by a user so as to modify said cancer treatment protocol for this patient. This can as an example include adjusting the cancer treatment protocol so that the future medications for this particular patient will be reduced.

In step (S4) 107, in case the toxicity level of said patient falls within said range of reference biomarkers of toxicity level (referring to the example above, is e.g. 1.2) or the toxicity level of said patient is considered acceptable by the clinician said patient's related data including said biomarkers of toxicity level are considered to qualify as reference data. In this case, the biomarkers of toxicity level for the patient and even all additional the patient's related data are subsequently added to the database of reference biomarkers of toxicity level. The reason of doing so is to continuously enlarge and thus improve the reference database. In that way, the different clinical institutes can build up and improve their database which is customized to the treatment protocol that is being implemented there. As an example, a university hospital may use different approaches than a community hospital, i.e. the treatment protocols may differ slightly. Thus, it may be difficult to use the same reference database having stored therein said reference biomarkers of toxicity level because of different treatment protocols. This continuous enlargement of the database may be done automatically so that the clinical expert does not need to be involved, or of course this may be done manually by e.g. the clinical expert.

FIG. 2 shows an embodiment of a system 200 according to the present invention for evaluating toxicity level of a patient 204 undergoing a cancer treatment protocol, where the system comprises a receiver (R) 201, a database 202 and a processor (P) 203. As depicted here, the system 200 may be integrated into a server 206 associated to a particular clinical institute 207.

The receiver (R) 201 is adapted to receive patient's related data 208 including biomarkers of toxicity level caused by said cancer treatment, where the receiver may e.g. be an access link to medical devices or databases storing the patient's related data 208, a disk drive for receiving any types of disk or portable storage means having storing the patient's related data 208, and the like. The database 202 stores a range of reference biomarkers of toxicity level caused during a similar cancer treatment, obtained for a number of reference patients 205, where these reference biomarkers of toxicity level are preferably obtained from patients that have undergone the cancer treatment protocol as defined by this particular (or similar) clinical institutes/hospitals.

The processor (P) 203 is adapted to compare said biomarkers of toxicity level with said range of reference biomarkers. The processor (P) 203 is further adapted to issue an alert signal in case said biomarkers of toxicity level fall outside said range of reference biomarkers of toxicity level. Suitable ways to deliver such alerts are pop-up windows showing respective text messages or highlighting of the abnormal values in the report form (e.g. by color coding). Additionally, in particular when the clinician is not logged on to the system 200, automatically generated e-mails with such messages may be sent.

The processor (P) 203 may further be adapted to build up and improve the database 202 by adding the patient's related data 208 to the reference data stored in the database in case the toxicity level of the patient 204 falls within said range of reference biomarkers of toxicity level. Accordingly, the patient will in this case be considered as reference patient, i.e. a “normal” patient having an acceptable level of toxicity. In that way, since the patient 204 has undergone the cancer treatment protocol as defined by this particular clinical institute 207 the patient's related data 208 will be of high value for the reference data stored at the database 202, meaning that the reference data will be “customized” to this particular clinical institute 207.

As discussed in relation to FIG. 1, the cancer treatment protocol defines all relevant aspects of each supported treatment regime including timelines and the requested diagnostic procedures during treatment. A clinician may have certain choices within the treatment protocol. For example, a radiation oncologist may choose a particular drug and dose for induction chemotherapy and a particular irradiation scheme characterized by, for instance, intensity modulated radiation therapy with a specific number of portals, a specific number of fractions and a specific dose per fraction. The cancer treatment protocol thus provides well-defined schedules specific for the each treatment regime. For instance, it defines the dates at which specific doses of the applied drugs are delivered and may support the clinician by creating reminders sent for instance by e-mail to order patients for clinic visits and by ordering specific in-vitro diagnosis (IVD) tests as defined by the standard treatment regime. Examples of such IVD parameters are Glutamic-Pyruvic Transaminase (GPT), Glutamic-Oxaloacetic Transaminase (GOT), Gamma-Glutamyl Transpeptidase (Gamma-GT, GGT) for liver function, creatinine for kidney function, full blood count (FBC) for a variety of parameters associated with general health status, inflammation and damage to bone marrow, etc. The specific test and studies may be defined according to the guidelines of the hospital and clinic, respectively. To this end, the cancer treatment protocol may include a rule editor tool for special users, who are entitled to enter and modify clinical protocols in the system 200.

Furthermore, the cancer treatment protocol may be used to verify adherence of the executed treatment to the schedule. For instance, the clinician has to enter the results of the IVD tests and imaging studies in order to document that the required diagnostic steps have been adhered to in time. Alternatively, the data may be retrieved automatically from the respective information systems, e.g. Laboratory Information Systems (LIS). In a similar way, the actual delivery of the treatment (drug, irradiation) as required by the protocol has to be entered to the system. Again, if an oncology information system (OIS) or any equivalent system is available, the treatment information may be retrieved from this system automatically. In case of deviations from the standard protocol, the system 200 may provide rules how to deal with those deviations. For instance, the system 200 can suggest performing an additional irradiation at a day that normally would not have been part of the treatment course to compensate for a missing day (for instance because the patient did not show up for treatment). Monitoring deviations from the cancer treatment protocol may be relevant, because they may invalidate the processing steps previously discussed in relation to FIG. 1. In this case, the system 200 can provide information to the clinician that further monitoring of the patient by the system may not be covered by the available models.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

Reference signs are included in the claims, however the inclusion of the reference signs is only for clarity reasons and should not be construed as limiting the scope of the claims.

1. A method of evaluating toxicity level of a patient undergoing a cancer treatment protocol, comprising:
receiving patient's related data (101) including biomarkers of toxicity level caused by said cancer treatment,
comparing said biomarkers of toxicity level with a range of reference biomarkers of toxicity level (103) caused during a similar cancer treatment, and
issuing an alert signal (105) in case said biomarkers of toxicity level fall outside said range of reference biomarkers of toxicity level.

2. A method according to claim 1, wherein the cancer treatment protocol includes set of rules adapted to support a clinician at the respective clinical institute to adhere the cancer treatment protocol as defined by the respective clinical institute.

3. A method according to claim 2, wherein the set of rules are editable by a user as a response to said issued alert signal so as to modify said cancer treatment protocol.

4. A method according to claim 1, wherein in case the toxicity level of said patient falls within said range of reference biomarkers of toxicity level or if the toxicity level of said patient is considered to be acceptable (107), said patient's related data including said biomarkers of toxicity level are considered to qualify as reference data, the biomarkers of toxicity level for said patient subsequently being added to said reference biomarkers of toxicity level.

5. A method according to claim 4, wherein said step of adding the biomarkers of toxicity level for said patient subsequently to said reference biomarkers of toxicity level is done automatically.

6. A method according to claim 1, wherein the alert signal further includes adjustment data indicating how the cancer treatment should be adjusted in accordance to the issued alert signal.

7. A method according to claim 1, wherein said reference biomarkers of toxicity level are associated with patient's related reference data, where prior to comparing said biomarkers of toxicity level with said range of reference biomarkers of toxicity level, a classification is performed based on said patient's related data and said patient's related reference data so as to classify the patient into a category such that the patient's related data at least partly match the patient's related reference data, said comparing being based on comparing the biomarkers of toxicity level for the patient with reference biomarkers of toxicity level within the same or similar category.

8. A method according to claim 7, wherein the category is selected from one or more of the following:
the gender of the patient,
the age of the patient,
previous medical history of the patient,
the geographical origin of the patient, and
the treatment regime of the patient.

9. A method according to claim 1, wherein the patient's related data further include at least one of:
data relating to previous treatments the patient has already undergone, or
data indicating the drug the patient has been given during the previous treatments, or
data indicating the treatments the patient has not yet undergone, or
data indicating the dates of the previous or the coming treatments, or
data indicating the results of the previous treatments, or
an identifier that identifies the patient, or
a combination thereof.

10. A method according to claim 1, wherein said biomarkers of toxicity level caused by said cancer treatment are evaluated via linear combination of acquired biomarkers of toxicity level.

11. A method according to claim 10, wherein the linear combination includes at least one of:
a linear combination of the levels of the acquired biomarkers,
a slope of the biomarkers where a current biomarker level is compared with a prior biomarker level,
a curvature change of the biomarkers of toxicity level where the slope of two subsequent levels of a biomarker is compared with the slope of two subsequent levels of said biomarker at a subsequent point in time,
a liner combination of different biomarkers.

12. A computer program product for instructing a processing unit to execute the method step of claim 1 when the product is run on a computer.

13. A system (200) for evaluating toxicity level of a patient undergoing a cancer treatment protocol, comprising:
a receiver (201) adapted to receive patient's related data (208) including biomarkers of toxicity level caused by said cancer treatment,
a database (202) having stored therein a range of reference biomarkers of toxicity level caused during a similar cancer treatment,
a processor (203) adapted to:
compare said biomarkers of toxicity level with said range of reference biomarkers, and
issuing an alert signal in case said biomarkers of toxicity level fall outside said range of reference biomarkers of toxicity level.

14. A system according to claim 13, wherein the processor (203) is further adapted to, in case the toxicity level of said patient falls within said range of reference biomarkers of toxicity level or if the toxicity level of said patient is considered to be acceptable (107), add said patient's related data to said database (202) and thus consider said patient's related data (208) qualifying as reference data, whereby the biomarkers of toxicity level for said patient is subsequently being added to said reference biomarkers of toxicity level.
